(19) United States
(12) Patent Application Publication
(10) Pub. No.: US 2020/0130651 A1
(43) Pub. Date: Apr. 30, 2020

(54) CLEANING DEVICE FOR VEHICLES, AND METHOD FOR CLEANING SURFACES ON VEHICLES

(71) Applicant: Valeo Wischersysteme GmbH, Bietigheim-Bissingen (DE)

(72) Inventor: Siegfried Waible, Bietigheim-Bissingen (DE)

(21) Appl. No.: 16/607,438

(22) PCT Filed: Apr. 24, 2018
(86) PCT No.: PCT/EP2018/060450

§ 371 Date: Oct. 23, 2019

(30) Foreign Application Priority Data
Apr. 26, 2017 (DE) 10 2017 108 901.2

(51) Int. Cl. B60S 1/48; B08B 3/02; B60S 1/50; B60S 1/56

(52) U.S. Cl. CPC B60S 1/481; B60S 1/56; B60S 1/50; B08B 3/02

(57) ABSTRACT

The invention relates to a cleaning device for vehicles, having a reservoir for storing a cleaning fluid, having at least one feed pump to feed the cleaning fluid from the reservoir, having a plurality of spray devices for applying the cleaning fluid to surfaces to be cleaned, and having valve devices disposed in supply lines for the spray devices in order to control the flow of the cleaning fluid to the spray devices. According to the invention, it is provided that a buffer reservoir is provided for the cleaning fluid which is hydraulically connected to the high pressure side of the at least one feed pump, that the cleaning fluid is stored in the buffer reservoir under hydraulic pressure (P), and that the supply lines for the spray devices lead out from the buffer reservoir.

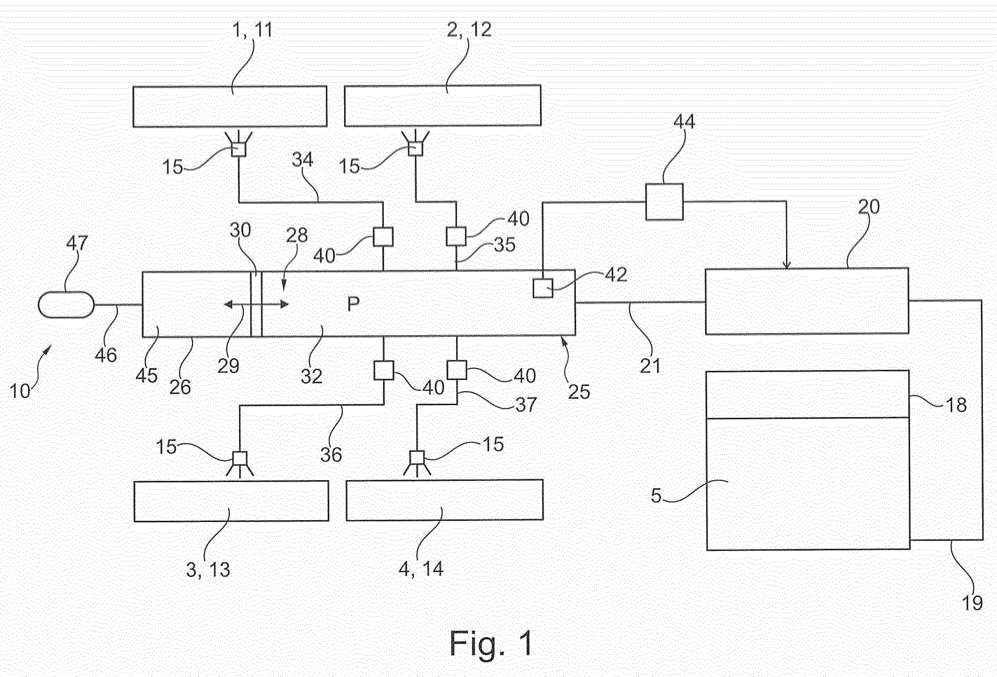

### PRIOR ART

The invention relates to a cleaning device for vehicles, and to a method for cleaning surfaces on vehicles according to the preambles of the two independent claims.

A cleaning device and a method for cleaning surfaces on vehicles with the features of the preambles of the two independent claims are known from DE 10 2014 200 097 A1. In the case of the known cleaning device and the known method for cleaning surfaces on vehicles, it is provided that cleaning fluid can be supplied by means of at least one feed pump, preferably by means of a plurality of feed pumps, both to spray nozzles on vehicle screens and also to spray nozzles which serve for cleaning sensor surfaces. For this purpose, a branching element is arranged in the region of a supply line which connects the at least one feed pump to a plurality of spray nozzles, said branching element being in the form of a valve device, via which the cleaning fluid can be supplied as needed to different surfaces to be cleaned (vehicle screen, sensor surface) or to spray nozzles. A disadvantage of the cleaning device known from the document mentioned and of the known method for cleaning surfaces on vehicles is that, when a plurality of feed pumps are used, the outlay in terms of design is relatively high and a relatively large amount of space is required and such a cleaning device has high costs. Furthermore, the full pressure of the cleaning fluid in the region of the spray nozzle is always applied only with a certain time delay since the pressure first of all has to be built up by the feed pump.

### DISCLOSURE OF THE INVENTION

The cleaning device according to the invention for vehicles and the method according to the invention for cleaning surfaces on vehicles with the features of the two independent claims has the advantage that a cleaning device is made possible which requires a relatively low outlay in terms of apparatus and which furthermore permits particularly effective and rapid cleaning of surfaces.

The invention is based on the concept of using a single feed pump to feed the cleaning fluid from the reservoir into a buffer reservoir, in which the cleaning fluid is temporarily stored at a relatively high pressure. Supply lines to the individual use points or to the surfaces to be cleaned lead out from the buffer reservoir, wherein valve devices are inserted in the supply lines and control the inflow of the cleaning fluid to the spray devices at the surfaces to be cleaned.

By the cleaning fluid being stored in the buffer reservoir under a relatively high pressure, after appropriate activation of the valve devices the corresponding pressure is directly applied, i.e. without a time delay, in the region of the spray device since the pressure does not have to be built up first by the feed pump. Furthermore, a decoupling of the operation of the feed pump respectively the cleaning of the surfaces from the operation of the feed pump can take place, since the spray devices, even without the feed pump having to be operated, can be supplied with the cleaning fluid from the buffer reservoir at least for a certain time.

In particular, the use of a buffer reservoir provided according to the invention makes it possible to supply a multiplicity of different consumers or different surfaces to be cleaned with the cleaning fluid with little outlay, and, furthermore, the advantage is achieved that greater flexibility in respect of siting the reservoir for the cleaning fluid can be achieved by the buffer reservoir since the reservoir and the feed pump interacting with the reservoir can be positioned, for example, at a location arranged relatively far from the individual consumers. Of advantage in respect of the buffer reservoir is simply an installation site which, with respect to the surfaces to be cleaned or the arrangement of the spray devices, is at a relatively small distance therefrom.

Advantageous developments of the cleaning device according to the invention for vehicles and of the method for cleaning surfaces on vehicles are cited in the respective dependent claims. All combinations of at least two of the features disclosed in the claims, the description and/or the figures fall within the scope of the invention.

In a particularly preferred structural refinement of the cleaning device, it is provided that a pressure increasing device which is separate from the at least one feed pump is associated with the buffer reservoir and is configured in order to pressurize the cleaning fluid in the buffer reservoir. Such a separate pressure increasing device can be present, for example, in the form of a mechanical element, for example a pretensioned spring, which hydraulically pressurizes the cleaning fluid in the buffer reservoir via a suitable, in particular piston-like arrangement. However, it can also be provided that the pressure increasing device is formed in the form of a pressure chamber which is separate from the buffer reservoir, or else is configured as part of the buffer reservoir and is pneumatically or hydraulically over-pressurized and thereby likewise exerts a hydraulic pressure on the buffer reservoir or on the cleaning fluid in the buffer reservoir.

The cleaning device described to this extent is therefore particularly advantageous since supply of the spray devices with cleaning fluid is made possible even if the feed pump itself is not active at least for a certain period of time. Furthermore, by appropriate configuration of the separate pressure increasing device, the latter is capable of keeping the hydraulic cleaning fluid pressure prevailing in the buffer reservoir at a constant level even when cleaning fluid is extracted through the spray nozzles.

The higher the hydraulic pressure of the cleaning fluid or of the cleaning fluid to be sprayed onto the surface to be cleaned is, the better is the cleaning action since, as a result, improved dissolution or breaking away of dirt particles can be achieved by the cleaning fluid. This requires that the buffer reservoir firstly has to be configured for maintaining the desired pressure of the cleaning fluid and secondly should also be configured to interact with the intended pressure increasing device which in particular has a piston which defines the volume for the cleaning fluid in the buffer reservoir. In view of these statements, it is provided, in a further advantageous refinement of the cleaning device, that the buffer reservoir has a rigid outer wall, and that a movably guided piston is disposed in the interior of the buffer reservoir, defining a storage chamber for the cleaning fluid on a front side of the piston.

In a structural development of the last-mentioned proposal, it is provided that on the side facing away from the storage chamber, the piston is urged in the direction of the storage chamber by means of hydraulic or pneumatic pressure or by means of mechanical resilient force.

In order to permit appropriate activation of the feed pump in such a manner that a certain minimum pressure of the cleaning fluid is always present in the buffer reservoir, it is furthermore provided, in a further advantageous refinement, that pressure measurement means are provided for at least indirect measurement of the hydraulic pressure of the cleaning fluid in the buffer reservoir, and that the at least one feed pump is configured in a manner such that when the pressure of the cleaning fluid falls below a minimum, the pressure of the cleaning fluid is raised by feeding cleaning fluid from the reservoir into the buffer reservoir.

Particularly rapid and simple activation of the valve devices is made possible if the latter are configured as electromagnetically actuatable valve devices. Furthermore, it can be advantageous to arrange said valve devices as close as possible to, i.e. at a small distance from, the spray devices, or optionally to configure the valve device together with the spray device as a common constructional unit.

The cleaning device according to the invention described to this extent is furthermore suitable, in addition to the cleaning of vehicle screens, for cleaning other surfaces to be cleaned, for example headlights, or else sensor surfaces of driver assistance systems.

Further advantages, features and details of the invention emerge from the description below of preferred exemplary embodiments and with reference to the drawing.

The latter shows, in the single FIGURE, a simplified schematic illustration of a cleaning device according to the invention for cleaning different surfaces on a vehicle.

The cleaning device 10, which is illustrated in the FIGURE, for vehicles, in particular for road vehicles, serves for cleaning surfaces 1 to 4 of the vehicle by means of a cleaning fluid 5 which preferably comprises at least water. By way of example, and not in a restricting manner, the surface 1 is the surface 1 of a vehicle screen 11, the surface 2 is the surface 2 of a front headlight 12, the surface 3 is the surface 3 of a reversing camera 13 of a driver assistance system, and the surface 4 is a further camera 14, for example a camera 14 arranged in a rear view mirror or a camera 14 arranged at the front of the vehicle.

In addition, it is pointed out that additional use points or else different use points than those described and which are intended to be cleaned with the cleaning fluid 5 by means of the cleaning device 10 can be provided. The cleaning fluid 5 is applied to the respective surface 1 to 4 in particular, but not in a restricting manner, by means of spray devices 15 which are known per se.

The cleaning device 10 comprises a reservoir 18 for the cleaning fluid 5. The reservoir 18 is connected to the suction side of a high pressure pump 20 via a suction line 19. The high pressure side of the high pressure pump 20 is connected via a pressure line 21 to a buffer reservoir 25 which, for example, is tubular and into which the high pressure pump 20 feeds the cleaning fluid 5, thereby increasing the pressure. The buffer reservoir 25 preferably has a cylindrical cross section with an outer wall 26 which is configured rigidly. Preferably, but not in a restricting manner, the buffer reservoir 25 can be composed, for example, of aluminium or an aluminium alloy, or else of stainless steel or another suitable material.

The interior 28 of the buffer reservoir 25 is divided by a piston 30 arranged in a longitudinally displaceable manner in the direction of the double arrow 29 in the interior 28. The piston 30 bears in a sealing manner against the inner wall of the buffer reservoir 25. Within the interior 28, the piston 30 defines a storage chamber 32 for the cleaning fluid 5, which storage chamber is hydraulically connected to the pressure side of the high pressure pump 30 via the pressure line 21. A supply line 34 to 37, by way of example for each surface 1 to 4 to be cleaned, leads off from the storage chamber 32 and is connected to the respective spray device 15 with the interconnection of an electromagnetically actuatable valve 40. According to the driver's requirements, the valve 40 is activated by actuation of a corresponding switch or optionally fully automatically in order to permit the inflow of cleaning fluid 5 from the buffer reservoir 25 to the spray device 15 assigned to the surface 1 to 4.

The cleaning fluid 5 is stored in the storage chamber 32 at a defined minimum pressure Pₘᵢₙ of, for example, 3 bar, preferably more than 3 bar. The hydraulic pressure P of the cleaning fluid 5 in the storage chamber 32 is measured at least indirectly by means of a pressure sensor 42. The output signal from the pressure sensor 42 is supplied to a control device 44 as an input variable which activates the high pressure pump 20 when the pressure falls below the minimum pressure Pₘᵢₙ, and therefore the hydraulic pressure P of the cleaning fluid 5 in the storage chamber 32 is raised, specifically at least to the minimum pressure Pₘᵢₙ, preferably by a defined amount higher than the minimum pressure Pₘᵢₙ.

In order, when cleaning fluid 5 is extracted from the storage chamber 32 of the buffer reservoir 25, always to ensure a desired minimum pressure Pₘᵢₙ even without actuation of the high pressure pump 20, the interior 28 of the buffer reservoir 25 on that side of the piston 30 which faces away from the storage chamber 32 forms a pressure chamber 45 which forms a pressure increasing device. The pressure chamber 45 can be configured as a closed pressure chamber 45 and can be filled with a gas which is under positive pressure, for example with nitrogen. Alternatively, the pressure chamber 45 can be connected to a high pressure reservoir 47, for example via a supply line 46. The high pressure reservoir 47 is, for example, a compressor or a hydraulic pump which is configured to act upon the pressure chamber 45 with a corresponding hydraulic or pneumatic pressure in such a manner that the piston 30 is urged in the direction of the storage chamber 32.

Alternatively in turn, it can also be provided that a mechanical compression spring is arranged within the pressure chamber 45 and is supported within the buffer reservoir 25 and acts upon the piston 30 with a mechanical resilient force likewise in the direction of the storage chamber 32.

The cleaning device 10 described to this extent can be modified in diverse ways without departing from the inventive concept.

### REFERENCE SIGNS

1 surface
2 surface
3 surface
4 surface
5 cleaning fluid
10 cleaning device
11 vehicle screen
12 front headlight
13 reversing camera
14 camera
15 spray device
18 reservoir
19 suction line
20 high pressure pump
21 pressure line
25 buffer reservoir
26 outer wall
28 interior
29 double arrow
30 piston
32 storage chamber
34 supply line
35 supply line
36 supply line
37 supply line
40 valve
42 pressure sensor
44 control device
45 pressure chamber
46 supply line
47 high pressure reservoir
P pressure
Pₘᵢₙ minimum pressure

1. A cleaning device for vehicles, having a reservoir for storing a cleaning fluid, having at least one feed pump to feed the cleaning fluid from the reservoir, having a plurality of spray devices for applying the cleaning fluid to one or more surfaces to be cleaned, and having one or more valve devices disposed in one or more supply lines for the spray devices in order to control the flow of the cleaning fluid to the plurality of spray devices,
characterized in that
a buffer reservoir is provided for the cleaning fluid which is hydraulically connected to a high pressure side of the at least one feed pump, in that the cleaning fluid is stored in the buffer reservoir under hydraulic pressure (P), and in that the plurality of supply lines for the plurality of spray devices lead out from the buffer reservoir.

2. The cleaning device as claimed in claim 1, characterized in that:
a pressure increasing device which is separate from the at least one feed pump is associated with the buffer reservoir and is configured in order to pressurize the cleaning fluid in the buffer reservoir.

3. The cleaning device as claimed in claim 1, characterized in that
the buffer reservoir has a rigid outer wall, and in that a movably guided piston is disposed in the interior of the buffer reservoir, defining a storage chamber for the cleaning fluid with a front side of the piston.

4. The cleaning device as claimed in claim 3, characterized in that
on a side facing away from the storage chamber, the piston is urged in the direction of the storage chamber by means of a hydraulic or a pneumatic pressure or by means of a mechanical resilient force.

5. The cleaning device as claimed in claim 4, characterized in that
a pressure measurement means are provided for at least indirect measurement of the hydraulic pressure (P) of the cleaning fluid in the buffer reservoir, and in that the at least one feed pump is configured in a manner such that when the pressure falls below a minimum (Pₘᵢₙ), the hydraulic pressure (P) is raised above the minimum pressure (Pₘᵢₙ) by feeding the cleaning fluid from the reservoir into the buffer reservoir.

6. The cleaning device as claimed in claim 1, characterized in that
the one or more valve devices comprises an electromagnetically actuatable valve devices.

7. The cleaning device as claimed in claim 1, characterized in that
in addition to at least one vehicle screen, the surfaces to be cleaned comprise at least one lighting system to be cleaned, an element of a driver assistance system to be cleaned, or both.

8. A method for cleaning one or more surfaces on a vehicle, with a reservoir for storing a cleaning fluid, with at least one feed pump for feeding the cleaning fluid from the reservoir, with a plurality of spray devices for applying the cleaning fluid onto the one or more surfaces to be cleaned, and with one or more valve devices disposed in one or more supply lines for the plurality of spray devices for controlling a flow of the cleaning fluid to the spray devices,
characterized in that
the cleaning fluid is fed from the at least one feed pump out of the reservoir into a buffer reservoir in which the cleaning fluid is stored under a pressure (P), and in that the cleaning fluid is fed from the buffer reservoir via the supply lines to the plurality of spray devices.

9. The method as claimed in claim 8,
characterized in that
the at least one feed pump is controlled in a manner such that the cleaning fluid in the buffer reservoir is permanently at a minimum pressure (Pₘᵢₙ).

10. The method as claimed in claim 8, characterized in that the cleaning fluid comprises at least water.

11. A cleaning device for vehicles, having a reservoir for storing a cleaning fluid, having at least one feed pump to feed the cleaning fluid from the reservoir, having a plurality of spray devices for applying the cleaning fluid to one or more surfaces to be cleaned, and having one or more valve devices disposed in one or more supply lines for the spray devices in order to control the flow of the cleaning fluid to the plurality of spray devices,
characterized in that
a buffer reservoir is provided for the cleaning fluid which is hydraulically connected to a high pressure side of the at least one feed pump, in that the cleaning fluid is stored in the buffer reservoir under hydraulic pressure (P), and in that the plurality of supply lines for the plurality of spray devices lead out from the buffer reservoir;
wherein a pressure increasing device which is separate from the at least one feed pump is associated with the buffer reservoir and is configured in order to pressurize the cleaning fluid in the buffer reservoir;
wherein the buffer reservoir has a rigid outer wall, and in that a movably guided piston is disposed in the interior of the buffer reservoir, defining a storage chamber for the cleaning fluid with a front side of the piston;
wherein on a side facing away from the storage chamber, the piston is urged in the direction of the storage chamber by means of a hydraulic or a pneumatic pressure or by means of a mechanical resilient force;
wherein a pressure measurement means are provided for at least indirect measurement of the hydraulic pressure (P) of the cleaning fluid in the buffer reservoir, and in that the at least one feed pump is configured in a manner such that when the pressure falls below a minimum (Pₘᵢₙ), the hydraulic pressure (P) is raised above the minimum pressure (Pₘᵢₙ) by feeding the cleaning fluid from the reservoir into the buffer reservoir.

12. The cleaning device as claimed in claim 11, characterized in that
the one or more valve devices comprises an electromagnetically actuatable valve devices.

13. The cleaning device as claimed in claim 11, characterized in that
in addition to at least one vehicle screen, the surfaces to be cleaned comprise at least one lighting system to be cleaned, an element of a driver assistance system to be cleaned, or both.
